(19) United States
(12) Patent Application Publication
(10) Pub. No.: US 2016/0290244 A1
(43) Pub. Date: Oct. 6, 2016

(54) CONTROL DEVICE FOR INTERNAL COMBUSTION ENGINE

(71) Applicant: Toyota Jidosha Kabushiki Kaisha, Toyota-shi Aichi-ken (JP)

(72) Inventor: Toshikazu Kato, Toyota-shi Aichi-ken (JP)

(21) Appl. No.: 15/088,708

(22) Filed: Apr. 1, 2016

(30) Foreign Application Priority Data
Apr. 2, 2015 (JP) 2015-075879

(51) Int. Cl. F02D 13/02; F01L 1/34

(52) U.S. Cl. CPC F02D 13/0234; F01L 1/34

(57) ABSTRACT

A control device for an engine provided in a vehicle includes a controller. The engine includes an intake valve and a variable valve mechanism. The variable valve mechanism changes an opening/closing timing while maintaining a valve opening period of the intake valve. The controller sets an advance amount of the closing timing of the intake valve at the time when the engine is started, such that a first closing timing is earlier than a second closing timing of the intake valve. The first closing timing is the closing timing when a trip in which an operating period of the internal combustion engine is equal to or less than a predetermined period continues a predetermined number of times. The second closing timing is the closing timing before the number of continuous trips reaches the predetermined number of times. The trip is a period from activation to stop of the vehicle.

### CROSS-REFERENCE TO RELATED APPLICATIONS

The present disclosure claims priority to Japanese Patent Application No. 2015-075879 filed on Apr. 2, 2015, which is incorporated herein by reference in its entirety including the specification, drawings and abstract.

### BACKGROUND

1. Technical Field

The present disclosure relates to a control device for an internal combustion engine, and particularly, to a control device for an internal combustion engine that can change an opening/closing timing of an intake valve.

2. Description of Related Art

There has been known an internal combustion engine provided with a variable valve mechanism (hereinafter also referred to as a VVT mechanism) in which an opening/closing timing of an intake valve changes.

Japanese Patent Application Publication No. 2013-139227 (JP 2013-139227 A) describes a vehicle that executes a pressure reduction control to retard a valve opening timing of an intake valve of an internal combustion engine, with respect to an intake-side VVT mechanism, as a control to improve startability of the internal combustion engine. The pressure reduction control to improve the startability is also referred to as a “startup pressure reduction control” or a “decompression control.” When the valve opening timing of the intake valve of the engine is retarded, an effective compression ratio is reduced, thereby making it possible to improve the startability of the engine.

### SUMMARY

When the pressure reduction control is executed by the intake-side VVT mechanism like the technique described in JP 2013-139227 A, an effective compression ratio decreases. Because of this, a combustion temperature decreases, so a temperature of an ignition plug is hard to increase. Particularly, under a low temperature, when an operation of a vehicle is repeatedly stopped within an extremely short operating time at a temperature that is not more than a self-cleaning temperature of the ignition plug, soot may be attached to the ignition plug. This causes a misfire or the like, which may impair a comfortable operation. Hereinafter, in the present specification, a period after a system of the vehicle is started but before the system is stopped (from Ready-ON to Ready-OFF or from IG-ON to IG-OFF) is referred to as a “trip.” Further, to terminate the operation of the vehicle within an extremely short operating time is referred to as a “short trip.”

Particularly, in a case of a hybrid vehicle and a plug-in hybrid vehicle, in order to improve fuel efficiency or to reduce a shock at the time of engine start, a retarding process of largely delaying a closing timing of the intake valve is performed by the intake-side VVT mechanism. On the other hand, in a case of the hybrid vehicle and the plug-in hybrid vehicle, when an engine intermittent operation or the like is executed, the operating time of the engine is shortened. As a result, soot may be attached to the ignition plug, which may cause a misfire.

The disclosure provides a control device for an internal combustion engine, the control device being able to reduce malfunctions such as a misfire of the internal combustion engine.

An example aspect of the disclosure provides a control device for an internal combustion engine, the internal combustion engine is provided in a vehicle, the internal combustion engine includes an intake valve and a variable valve mechanism, the variable valve mechanism is configured to change an opening timing and a closing timing of the intake valve while maintaining a valve opening period of the intake valve, the control device includes a controller. The controller is configured to set an advance amount of the closing timing of the intake valve at the time when the internal combustion engine is started, such that a first closing timing of the intake valve is earlier than a second closing timing of the intake valve. The first closing timing is the closing timing when a trip in which an operating period of the internal combustion engine is equal to or less than a predetermined period continues a predetermined number of times. The second closing timing is the closing timing before the number of continuous trips reaches the predetermined number of times. The trip is a period from activation of the vehicle to stop of the vehicle.

In the control device, the controller may be configured to set an advance amount of the variable valve mechanism to a most retarded position before the number of continuous trips reaches the predetermined number of times.

In a case of the internal combustion engine including a variable valve mechanism, the internal combustion engine is operated so as to achieve a low compression and a high expansion ratio, thereby improving fuel efficiency. However, when a short trip is repeated continuously under a low temperature, adhesion of soot to an ignition plug is promoted, which may cause a misfire of the internal combustion engine. Accordingly, in a case where the short trip is repeated, when such a control is performed, startability of the internal combustion engine improves and a combustion temperature also increases. This results in that the soot attached to the ignition plug is burnt to clean up the ignition plug.

In the control device, the controller may be configured to count up a counting value that counts the number of continuous trips, when an operating time of the internal combustion engine in a immediately preceding trip is equal to or less than the predetermined period when the vehicle stops. The controller may be configured to clear the counting value at the time when at least any one of the following conditions is established: a condition that a coolant temperature of a coolant of the internal combustion engine at the activation of the vehicle is higher than a predetermined temperature; a condition that the operating period of the internal combustion engine per one operation of the vehicle exceeds the predetermined period; and a condition that the coolant temperature at the time when the vehicle operation is finished is higher than a predetermined temperature.

When fuel is burnt in the internal combustion engine under a high temperature, the soot attached to the ignition plug is also burnt together, so that the ignition plug is cleaned up. As described above, it is estimated that burning is performed at a high temperature when any of the following conditions is detected: a condition that the coolant temperature of the coolant at the activation of the vehicle is high; a condition that the operating time of the internal combustion engine per one operation is long; and a condition that the coolant temperature of the coolant at the time when the vehicle operation is finished is high. As a result, it is also expected that the ignition plug is cleaned up. In such a case, in order to put back the variable valve mechanism to an original setting so as to improve the fuel efficiency, the control device clears the counting value.

In the control device, the variable valve mechanism may be an electrically driven mechanism. If the variable valve mechanism is a hydraulic type, a motor pump that is powered by the internal combustion engine is often employed for hydraulic generation. However, in this case, no hydraulic pressure occurs at the time when the internal combustion engine is started, and it is difficult to freely set the advance amount of the variable valve mechanism. If the variable valve mechanism is an electrically driven mechanism, such a problem does not occur, and the advance amount can be set freely even at the time when the internal combustion engine is started.

The vehicle may include a motor, the motor may be used with the internal combustion engine as a drive source. The vehicle may include a power storage device configured to supply an electric power to the motor, and the power storage device may be configured to be chargeable from outside the vehicle.

In a case of a hybrid vehicle and a plug-in hybrid vehicle, the frequency to operate the internal combustion engine decreases as compared with normal vehicles, and even if the internal combustion engine is started, the internal combustion engine is often stopped immediately. Accordingly, a short trip that causes soot to be attached to the ignition plug easily occurs. In view of this, the above configuration is particularly effective to the hybrid vehicle and the plug-in hybrid vehicle.

Another example aspect of the disclosure provides a control method for an internal combustion engine, the internal combustion engine is provided in a vehicle, the internal combustion engine includes an intake valve and a variable valve mechanism, the variable valve mechanism is configured to change an opening timing and a closing timing of the intake valve while maintaining a valve opening period of the intake valve, the control method comprising: setting an advance amount of a closing timing of the intake valve at the time when the internal combustion engine is started, such that a first closing timing of the intake valve is earlier than a second closing timing of the intake valve, the first closing timing being the closing timing when a trip in which an operating period of the internal combustion engine is equal to or less than a predetermined period continues a predetermined number of times, the second closing timing being the closing timing before the number of continuous trips reaches the predetermined number of times, the trip being a period from activation of the vehicle to stop of the vehicle.

According to the above configuration, since the ignition plug of the internal combustion engine is kept clean, it is possible to reduce malfunctions such as a misfire of the internal combustion engine.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a view illustrating a basic configuration of a hybrid vehicle according to an embodiment;

FIG. 2 is a view illustrating a configuration of an engine illustrated in FIG. 1;

FIG. 3 is a view illustrating a relationship between a valve displacement amount and a crank angle, the relationship being realized in an electric VVT device;

FIG. 4 is a flow chart to describe a first process of cleaning up an ignition plug, the first process being executed by a control device;

FIG. 5 is a flow chart to describe a second process of cleaning up the ignition plug, the second process being executed by the control device; and

FIG. 6 is a flow chart to describe a third process of cleaning up the ignition plug, the third process being executed by the control device.

### DETAILED DESCRIPTION OF EMBODIMENTS

The following describes an embodiment in detail with reference to the drawings. Note that the same or equivalent portions in the drawings have the same reference sign and descriptions thereof are not repeated.

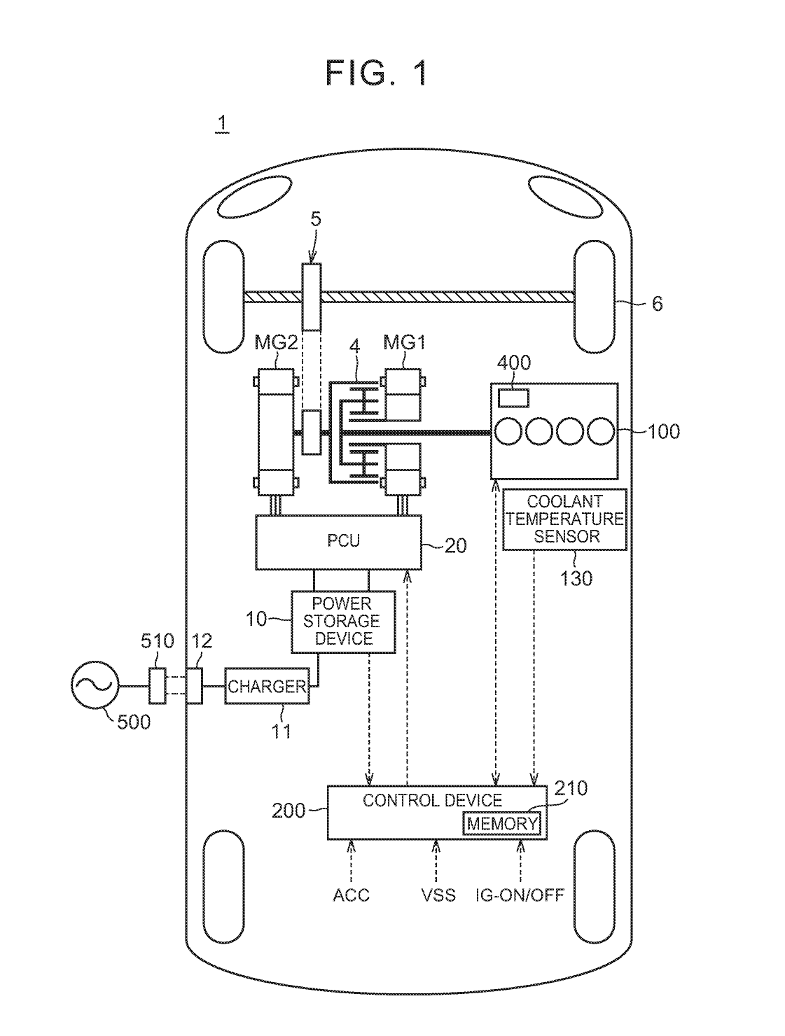

FIG. 1 is a view illustrating basic configuration of a hybrid vehicle according to the present embodiment.

Referring now to FIG. 1, the hybrid vehicle (hereinafter just referred to the vehicle) 1 includes an engine 100, motor generators MG1, MG2, a power distribution device 4, a speed reducer 5, drive wheels 6, a power storage device 10, an inlet 12, a charger 11, a power control unit (PCU) 20, a coolant temperature sensor 130, and a control device 200.

The vehicle 1 can run by a driving force output from at least one of the engine 100 and the motor generator MG2. The engine 100 is constituted by an internal combustion engine such as a gasoline engine or a diesel engine, for example. The engine 100 supplies a power to at least either of the drive wheels 6 and the motor generator MG1 operable as a generator, via the power distribution device 4.

The engine 100 can be started by being cranked by the motor generator MG1. The engine 100 includes an electric variable valve timing (VVT) device 400 for changing an operating characteristic of an intake valve. The electric VVT device 400 is controlled by the control device 200 according to a running state of the vehicle and startability of the engine 100.

The power distribution device 4 is configured to split a driving force generated from the engine 100 into a power to drive the drive wheels 6 via the speed reducer 5 and a power to drive the motor generator MG1. The power distribution device 4 is constituted by a planet gear mechanism, for example. In this case, for example, the motor generator MG1 is connected to a sun gear of the planet gear mechanism, the engine 100 is connected to a carrier of the planet gear mechanism, and the drive wheels 6 are connected to a ring gear of the planet gear mechanism via the motor generator MG2 and the speed reducer 5.

The motor generators MG1, MG2 are an AC rotary electric machine, e.g., a three-phase AC synchronous motor generator. The motor generator MG1 can generate an electric power by use of the power received from the engine 100 via the power distribution device 4. For example, when a state of charge (SOC) of the power storage device 10 reaches a lower limit control value, the engine 100 starts so that the motor generator MG1 generates an electric power. A voltage of the electric power generated by the motor generator MG1 is converted by the PCU 20, and then temporarily stored in the power storage device 10 or directly supplied to the motor generator MG2.

The motor generator MG2 generates a driving force by use of at least one of the electric power stored in the power storage device 10 and the electric power generated by the motor generator MG1. The driving force of the motor generator MG2 is transmitted to the drive wheels 6 via the speed reducer 5.

Note that, at the time of braking of the vehicle, the motor generator MG2 is driven by the drive wheels 6 via the speed reducer 5, so that the motor generator MG2 operates as a generator. Hereby, the motor generator MG2 operates as a regeneration brake that converts a brake energy into an electric power. The electric power generated by the motor generator MG2 is stored in the power storage device 10. In a case where a brake force larger than the regeneration brake of the motor generator MG2 is requested, a hydraulic brake (not shown) is used together.

The PCU 20 is a driving device for driving the motor generators MG1, MG2. The PCU 20 includes an inverter for driving the motor generators MG1, MG2, and may further include a converter for converting a voltage between the inverter and the power storage device 10.

The power storage device 10 is a chargeable direct-current power supply; and is constituted by a secondary battery such as nickel hydrogen battery or a lithium-ion battery, for example. The electric powers generated by the motor generators MG1, MG2 are stored in the power storage device 10. Note that a large-capacity capacitor can be employed as the power storage device 10, and any electric power buffer can be employed as the power storage device 10 provided that the electric power buffer is able to temporarily store the electric powers generated by the motor generators MG1, MG2 and can supply the electric powers thus stored to the motor generator MG2. Further, the power storage device 10 is provided with sensors for detecting a temperature, a voltage, and a current of the power storage device 10, and detection values by the sensors are output to the control device 200.

In some embodiments, the vehicle 1 is a plug-in hybrid vehicle. A connector 510 of a charger cable from a power supply 500 outside the vehicle can be connected to the inlet 12. The charger 11 receives a charging electric power from the power supply 500 outside the vehicle via the inlet 12, and charges the power storage device 10.

The control device 200 is constituted by a single or a plurality of electronic control units (ECUs). The ECU includes a memory 210 as a storage device, a central processing unit (CPU) (not shown), an input-output buffer, and the like. The memory 210 is configured to store at least part of data in a nonvolatile manner. The control device 200 performs an input of signals (an accelerator opening degree ACC, a vehicle speed VSS, and the like) from various sensors and an output of a control signal to each device, and also performs a control on each device in the hybrid vehicle 1. Mainly, the control device 200 executes a running control of the hybrid vehicle 1 and a control on the engine 100 (e.g., the electric VVT device 400 or the like) according to the running control. The operation of the control device 200 will be described later.

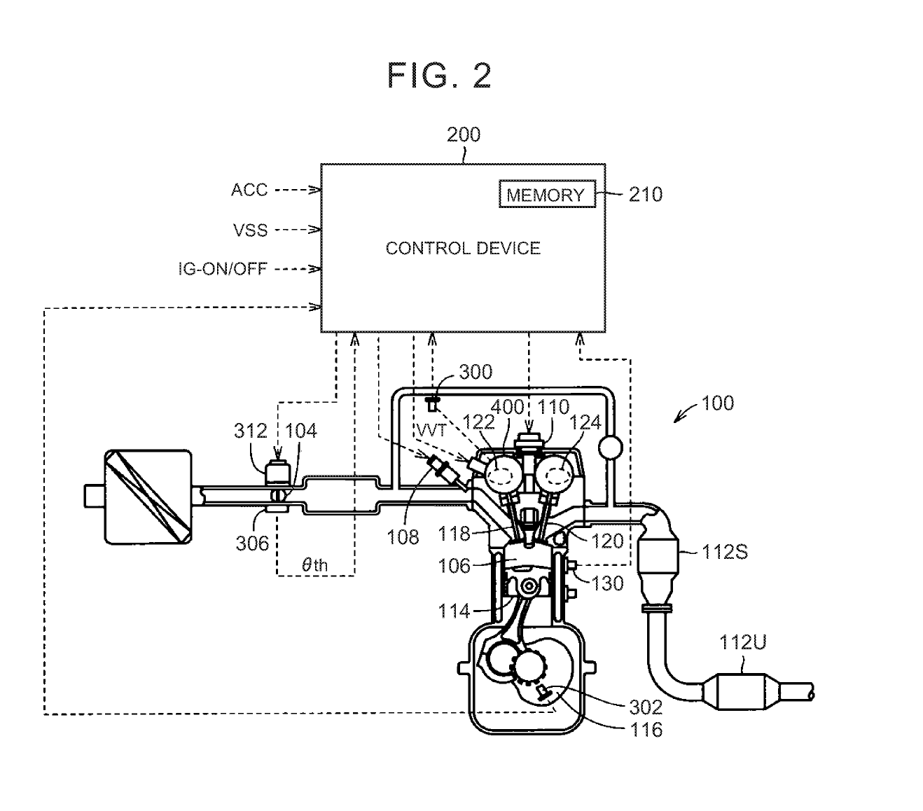

Next will be described a configuration of the engine 100 including the electric VVT device 400. FIG. 2 is a view illustrating the configuration of the engine 100 illustrated in FIG. 1.

Referring now to FIG. 2, an intake-air amount to the engine 100 is adjusted by a throttle valve 104 driven by a throttle motor 312. An injector 108 injects a fuel into an intake port. In the intake port, the fuel is mixed with air. When the intake valve 118 is opened, the fuel/air mixture is introduced in a cylinder 106. Note that the injector 108 may be provided as a direct-injection injector that directly injects the fuel into the cylinder 106. Alternatively, injectors 108 for port injection and for direct-injection may be provided.

The fuel/air mixture in the cylinder 106 is ignited by an ignition plug 110 and then burns. The fuel/air mixture after the burning, that is, an exhaust gas is exhausted to an exhaust passage. The exhaust passage is provided with an exhaust gas controlling apparatus that purifies the exhaust gas by a catalyst. The exhaust gas controlling apparatus includes a catalyst 112S (hereinafter also referred to as an S/C (start cat) catalyst), and a catalyst 112U (hereinafter also referred to as a U/F (underfloor) catalyst) placed on a downstream side relative to the S/C catalyst 112S. The exhaust gas is purified by the S/C catalyst 112S and the U/F catalyst 112U, and then exhausted outside the vehicle. A piston 114 is pushed down due to the burning of the fuel/air mixture, so that a crankshaft 116 rotates.

A head portion of the cylinder 106 is provided with the intake valve 118 and an exhaust valve 120. An amount of air introduced into the cylinder 106 and an introduction timing thereof are controlled by the intake valve 118. An amount of an exhaust gas exhausted from the cylinder 106 and an exhaust timing thereof are controlled by the exhaust valve 120. The intake valve 118 is driven by a cam 122, and the exhaust valve 120 is driven by a cam 124.

An operating characteristic of the intake valve 118 is changed by the electric VVT device 400. The electric VVT device 400 includes a camshaft, a cam sprocket, and an electric actuator (all not shown herein). The camshaft is rotatably provided in a cylinder head of the engine 100 so that a direction of a rotating shaft of the camshaft is parallel to a rotating shaft of the crankshaft. The camshaft includes an exhaust-side camshaft that opens and closes, by cams, exhaust valves provided in respective cylinders, and an intake-side camshaft that opens and closes, by cams, intake valves provided in respective cylinders. A plurality of cams 124 is fixed to the exhaust-side camshaft at predetermined intervals. A plurality of cams 122 is fixed to the intake-side camshaft at predetermined intervals.

Cam sprockets are provided in respective one ends of the intake-side and the exhaust-side camshafts. The same timing chain is wound around both cam sprockets. The timing chain is also wound around a timing rotor (not shown) provided in the crankshaft 116. Accordingly, the crankshaft and the cam shaft rotate in synchronization with each other via the timing chain.

An electric actuator is provided between the camshaft and the cam sprocket. The electric actuator changes a rotation phase between the camshaft and the cam sprocket on the intake side. An operation of the electric actuator is controlled based on a control signal VVT transmitted from the control device 200. When the electric actuator changes a rotation phase between the camshaft and the cam sprocket on the intake side, a valve opening period is maintained in the intake valve 118, and a valve opening timing and a valve closing timing in association with the valve opening timing are changed.

A change mode of the valve opening timing of the intake valve 118 by the electric VVT device 400 will be described later. Note that the electric VVT device 400 may change the valve opening timing of the exhaust valve 120 instead of or in addition to the intake valve 118.

Signals indicative of the accelerator opening degree ACC and the vehicle speed VSS and also signals from various sensors such as the coolant temperature sensor 130, a cam angle sensor 300, a crank angle sensor 302, and a throttle position sensor 306 are input into the control device 200.

The coolant temperature sensor 130 detects a temperature of a coolant flowing through a cooling channel of the engine, and transmits it to the control device 200. The cam angle sensor 300 outputs a signal indicative of a position of the cam. The crank angle sensor 302 outputs signals indicative of a rotation number (an engine rotation number) of the crankshaft 116 and a signal indicative of a rotation angle of the crankshaft 116. The throttle position sensor 306 outputs a signal indicative of a throttle opening degree θth. The control device 200 controls the engine 100 based on the signals from these sensors.

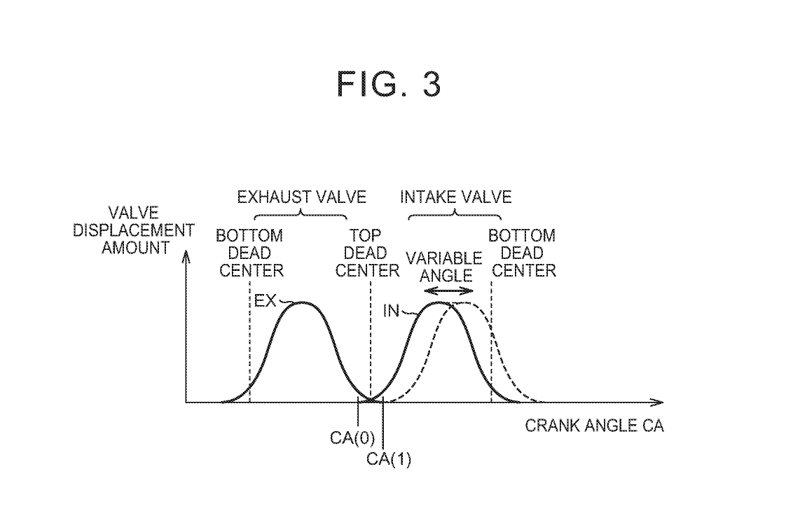

FIG. 3 is a view illustrating a relationship between a valve displacement amount and a crank angle, the relationship being realized in the electric VVT device 400. In FIG. 3, a vertical axis indicates the valve displacement amount, and a horizontal axis indicates the crank angle.

As illustrated in FIG. 3, in an exhaust stroke, the exhaust valve opened, and after a displacement amount thereof reaches its peak, the exhaust valve 120 is closed. After that, in an intake stroke, the intake valve 118 is opened, and after a displacement amount thereof reaches its peak, the intake valve 118 is closed. The valve displacement amount of the exhaust valve 120 is shown in a waveform EX, whereas the valve displacement amount of the intake valve 118 is shown in a waveform IN.

Note that the valve displacement amount indicates a displacement amount of the intake valve 118 from a state where the intake valve 118 (or the exhaust valve 120) is closed. A valve displacement amount at the time when the opening degree of the intake valve 118 reaches the peak is referred to as a lift amount, and a crank angle after the intake valve 118 is opened but before the intake valve 118 is closed is referred to as a working angle.

The electric VVT device 400 changes a valve opening timing and a valve closing timing of the intake valve 118 in a state where the lift amount and the working angle are maintained. That is, the electric VVT device 400 changes the valve opening timing between a continuous line and a broken line in the waveform IN in a state where its waveform is maintained. In the present embodiment, a crank angle CA(0) corresponds to a valve opening timing of the intake valve 118 in a case where the valve displacement amount is changed according to the waveform IN (the continuous line), and a crank angle CA(1) corresponds to a valve opening timing of the intake valve 118 in a case where the valve displacement amount is changed according to the waveform IN (the broken line).

In the following description, if the valve opening timing is changed in a direction from the crank angle CA(0) to the crank angle CA(1), it is expressed that the valve opening timing is “retarded,” and if the valve opening timing is changed in a direction from the crank angle CA(1) to the crank angle CA(0), it is expressed that the valve opening timing is “advanced.” Further, in the present embodiment, the crank angle CA(0) is a most advanced valve opening timing, and the crank angle CA(1) is a most retarded valve opening timing.

Note that, in the present embodiment, FIG. 3 exemplifies the waveform IN (the continuous line) of the valve displacement amount of the intake valve 118 at the most advanced timing and the waveform IN (the broken line) of the valve displacement amount of the intake valve 118 at the most retarded timing. However, a change range of the valve opening timing of the electric VVT device 400 is not limited to a range between CA(0) and CA(1) illustrated in FIG. 3 in particular.

Next will be described a cleaning process of the ignition plug of the engine. In a case of a hybrid vehicle or a plug-in hybrid vehicle provided with the electric VVT device 400 described in FIGS. 1 to 3, in order to improve fuel efficiency or to reduce a shock at the engine start, a retarding process of largely delaying a closing timing of the intake valve is performed by an intake-side VVT mechanism.

However, when the retarding process of largely delaying the closing timing of the intake valve is performed by the intake-side VVT mechanism, an effective compression ratio is lowered so that a combustion temperature decreases, thereby resulting in that a temperature of the ignition plug 110 is hard to increase. Particularly, when a short trip in which burning occurs in a cylinder at a temperature lower than a self-cleaning temperature of the ignition plug 110 is repeated, soot is attached to the ignition plug 110, so that a misfire or the like may occur, which may impair a comfortable operation.

In view of this, in the present embodiment, when adhesion of the soot to the ignition plug 110 is promoted, a process of burning the soot is performed. More specifically, the control device 200 counts the number of short trips continued under an environment that promotes the adhesion of the soot to the ignition plug 110, and when a counting value reaches a predetermined number, the control device 200 operates the engine under a condition in which the soot attached to the ignition plug 110 is burnt.

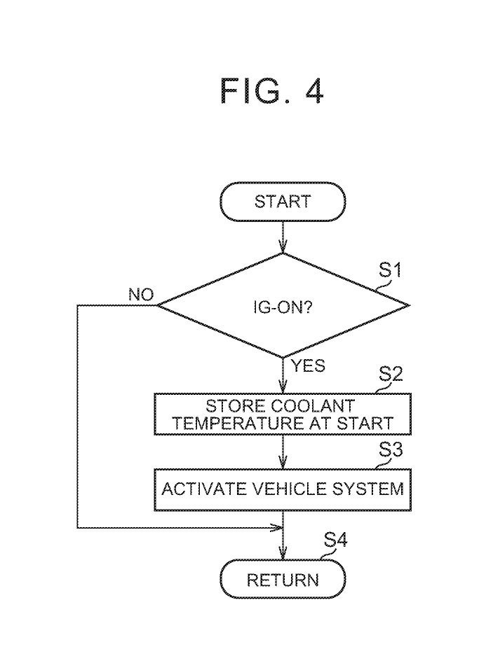

FIG. 4 is a flow chart to describe a first process of cleaning up the ignition plug, the first process being executed by the control device 200. This process is invoked from a predetermined main routine, and executed at the time when the vehicle is activated.

Referring now to FIGS. 2, 4, when a process of the flow chart is started, the control device 200 monitors whether a switch operation to activate the vehicle is performed or not, and determines whether the switch operation is for IG-ON or not, in step S1. For example, in a case where the switch operation is performed in a state where the vehicle is not activated, it is determined that the switch operation is for IG-ON (at the time of activating the vehicle system) (YES in step S1). Further, for example, in a case where the switch operation is performed in a state where the vehicle has been already activated, it is determined that the switch operation is for IG-OFF (at the time of stopping the vehicle system) (No in step S1).

The system activation switch is explained as a push button, but may be a key switch.

When it is determined in step S1 that the switch operation is for IG-ON, the process is advanced to step S2. When it is determined in step S1 that the switch operation is not for IG-ON, the process is advanced to step S4 and then returned.

In step S2, the control device 200 acquires an engine coolant temperature at the time of IG-ON from the coolant temperature sensor 130, and then stores it in the memory 210 as an activation coolant temperature ethwst. Then, in subsequent step S3, the control device 200 executes a remaining activation process of the vehicle system.

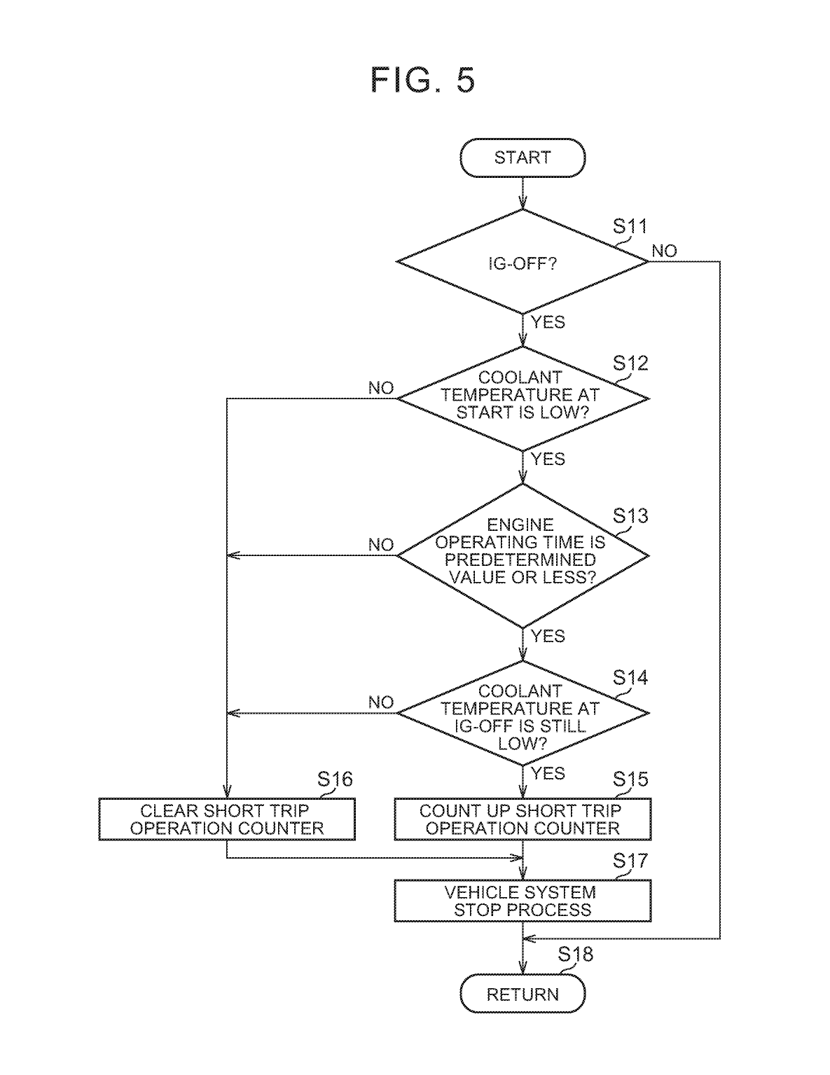

FIG. 5 is a flow chart to describe a second process of cleaning up the ignition plug, the second process being executed by the control device 200. This process is invoked from a predetermined main routine, and executed at the time when the operation of the vehicle is finished.

Referring now to FIGS. 2, 5, when a process of the flow chart is started, the control device 200 monitors whether a switch operation to activate the vehicle is performed or not, and determines whether the switch operation is for IG-OFF or not, in step S11. For example, in a case where the switch operation is performed in a state where the vehicle has been already activated, it is determined that the switch operation is for IG-OFF (at the time of stopping the vehicle system) (YES in step S11). Further, for example, in a case where the switch operation is performed in a state where the vehicle is not activated, it is determined that the switch operation is for IG-ON (at the time of activating the vehicle system) (NO in step S11).

When it is determined in step S11 that the switch operation is for IG-OFF, the process is advanced to step S12. When it is determined in step S11 that the switch operation is not for IG-OFF, the process is advanced to step S18.

In step S12, the control device 200 determines whether the activation coolant temperature ethwst stored in the memory 210 at the time when the vehicle is activated (at the time of IG-ON) is lower than a determination value or not. The determination value is a value determined, in advance, based on a temperature that easily causes adhesion of soot to the ignition plug 110.

When it is determined in step S12 that the activation coolant temperature ethwst is lower than the determination value (YES in step S12), the process is advanced to step S13. When it is determined in step S12 that the activation coolant temperature ethwst is not lower than the determination value (NO in step S12), the process is advanced to step S16.

In step S13, the control device 200 determines whether or not an engine operating time ecast from the activation of the vehicle system (IG-ON) to the stop of the vehicle system (IG-OFF) is a predetermined value or less. The predetermined value is predetermined in association with burning of the soot. If the engine operating time ecast is longer than the predetermined value, the engine reaches a sufficiently high temperature, thereby resulting in that the soot attached to the ignition plug 110 is burnt at the high temperature. If the engine operating time ecast is shorter than the predetermined value, the soot attached to the ignition plug 110 is not burnt but accumulated.

When it is determined in step S13 that the engine operating time ecast is equal to or less than the predetermined value (YES in step S13), the process is advanced to step S14. When it is determined in step S13 that the engine operating time ecast is not equal to or less than the predetermined value (NO in step S13), the process is advanced to step S16.

In step S14, the control device 200 determines whether a coolant temperature ethwed at the time of the stop of the vehicle system (IG-OFF), that is, at a current point, is lower than a determination value. In the short trip, the engine may stop without the engine being warmed up sufficiently. The determination value is a value predetermined based on a temperature that easily causes adhesion of soot to the ignition plug 110, and may be the same as or different from the determination value used in step S12.

When it is determined in step S14 that the coolant temperature ethwed is lower than the determination value (YES in step S14), the process is advanced to step S15. When it is determined in step S14 that the coolant temperature ethwed is not lower than the determination value (NO in step S14), the process is advanced to step S16.

In step S15, the control device 200 determines that the short trip that promotes adhesion of the soot to the ignition plug 110 is executed, and reads a discrete value of a short trip operation counter from the memory 210 so as to count up the discrete value. Then, the discrete value thus counted up is written into the memory 210 again.

In the meantime, in step S16, the control device 200 determines that the engine is operated under such a condition that the attached soot is burnt and the ignition plug 110 is cleaned up, and clears, to zero, the discrete value of the short trip operation counter, the discrete value being stored in the memory 210.

Due to the process in step S15 or step S16, a degree of progression of soot adherent to the ignition plug 110 is stored in a nonvolatile manner. Subsequently, a vehicle system stop process is performed in step S17, and the control is returned to a main routine in step S18.

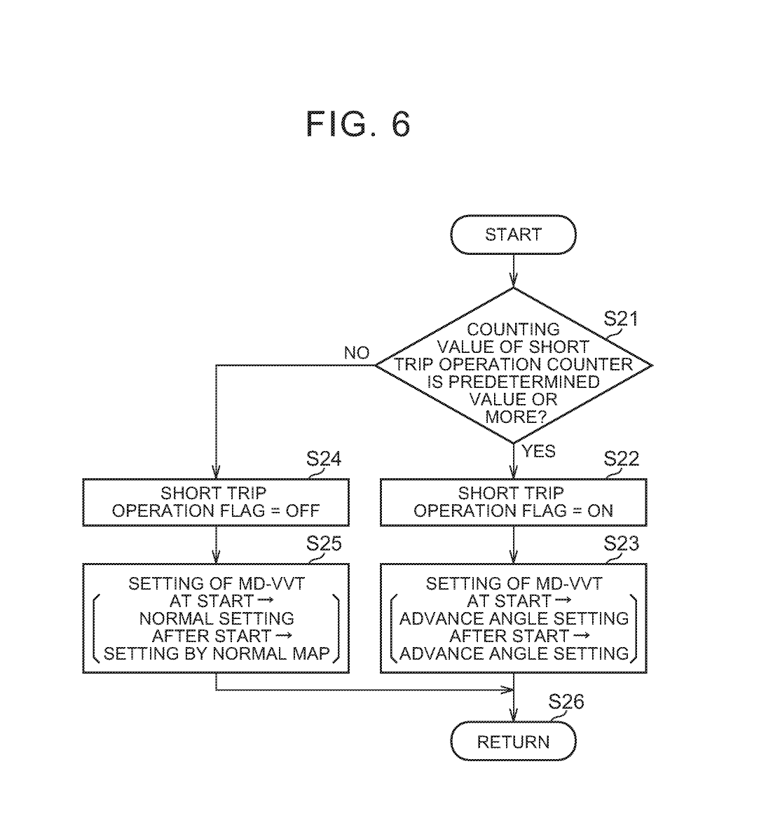

FIG. 6 is a flow chart to describe a third process of cleaning up the ignition plug, the third process being executed by the control device 200. This process is invoked from a predetermined main routine, and executed during the operation of the vehicle.

Referring now to FIGS. 2, 6, initially in step S21, the control device 200 determines whether or not the discrete value of the short trip operation counter is a predetermined value or more. The predetermined value is set to a value smaller than a number of times that promotes the accumulation of the soot to the ignition plug 110 and affects the operation of the engine.

When it is determined in step S21 that the discrete value of the short trip operation counter is the predetermined value or more (YES in step S21), the process is advanced to step S22. When it is determined in step S21 that the discrete value of the short trip operation counter is not the predetermined value or more (NO in step S21), the process is advanced to step S24.

In step S22, the control device 200 determines that the short trip that promotes adhesion of the soot to the ignition plug 110 continues a predetermined number of times, and turns on a short trip operation flag.

Subsequently, in step S23, the control device 200 sets an advance amount of the electric VVT device 400. This setting is performed such that the advance amount at the time of engine start is set to be more advanced than a normal time (a most retarded position), differently from the normal time. Hereby, since the closing timing of the intake valve in FIG. 3 approaches a bottom dead center, an air amount compressed inside an engine cylinder increases, so that an actual compression ratio increases. Even in a state where the atomization of the fuel in a cold state is bad, if the actual compression ratio is increased, the atomization of the fuel is improved, so that the fuel is easily fired. Accordingly, startability of the engine also improves and a combustion temperature after the start also increases, thereby making it possible to clean up the soot and the like attached to the ignition plug.

In a case where the VVT device is driven by a hydraulic pressure, a hydraulic pump does not turn around in a state where the engine does not rotate. Accordingly, the advance amount is at the most retarded position due to a biasing force by a spring or the like. In a case of a hydraulic system, if the hydraulic pump is electrically driven, the advance amount can be adjusted at the time of engine start. In the present embodiment, since the electric VVT device 400 is provided, the advance amount can be set freely even at the time of engine start.

Further, in terms of the advance amount after the engine start, if the advance amount is set to be more advanced than the normal time, cleaning of the soot and the like attached to the ignition plug can be promoted.

In a case where the process is advanced from step S21 to step S24, the control device 200 determines that the number of short trips that promote adhesion of the soot to the ignition plug 110 does not reach the predetermined number of times, and turns off the short trip operation flag.

Subsequently, in step S25, the control device 200 sets the advance amount of the electric VVT device 400. This setting is performed such that the advance amount at the time of engine start is set to an advance amount (the most retarded position) in the normal time. Hereby, since the closing timing of the intake valve in FIG. 3 is delayed relative to the bottom dead center, the air amount compressed inside the engine cylinder decreases, so that a low compression and a high expansion ratio are achieved, thereby improving fuel efficiency.

Note that the advance amount after the engine start is also set to an optimal value based on an engine rotation number, etc., by use of a map or the like similarly to the normal time, thereby improving the fuel efficiency.

As described above, in the present embodiment, when adhesion of the soot to the ignition plug is promoted, the soot is burnt so as to clean up the ignition plug. This makes it possible to restrain an occurrence of malfunctions such as a misfire of the internal combustion engine.

Lastly, the present embodiment is summarized with reference to FIGS. 1, 2 again. The vehicle 1 of the present embodiment includes the engine 100 and the control device 200. The engine 100 includes the intake valve 118, and the electric VVT device 400 that changes an opening timing and a closing timing of the intake valve 118 while maintaining a valve opening period of the intake valve 118. In a case where a trip (a short trip) in which an operating time of the engine 100 is a predetermined time or less continues a predetermined number of times within one trip from the activation of the vehicle 1 to the stop of the vehicle 1, the control device 200 sets the advance amount so that a closing timing (a first closing timing) of the intake valve at the time of start of the engine 100 comes earlier than a closing timing (a second closing timing) before the number of continuous short trips reaches the predetermined number of times.

The control device 200 sets the advance amount of the electric VVT device 400 to a most retarded position before the number of continuous short trips reaches the predetermined number of times.

In a case of the engine 100 including the electric VVT device 400, the engine 100 is operated so as to achieve a low compression and a high expansion ratio, thereby improving fuel efficiency. In this case, when the short trip is repeated under a low temperature, adhesion of the soot to the ignition plug 110 is promoted, which may cause a misfire of the engine 100. With the aforementioned control, the startability of the engine 100 improves and the combustion temperature also increases, thereby resulting in that the attached soot is burnt so as to clean up the ignition plug 110.

In some embodiments, the control device 200 clears a counting value when at least one of the coolant temperature of the coolant at the activation of the vehicle, the operating time of the engine 100 per one operation, and the coolant temperature of the coolant at the time when the vehicle operation is finished satisfies a cleaning condition of the ignition plug 110 (a condition that the soot is presumably burnt). More specifically, the control device 200 clears the counting value at the time when any of the following conditions is satisfied: a condition that the coolant temperature of the coolant at the activation of the vehicle is higher than a predetermined temperature; a condition that the operating time of the internal combustion engine per one trip exceeds a predetermined time; and a condition that the coolant temperature of the coolant at the time when the vehicle operation is finished is higher than a predetermined temperature.

When the fuel is burnt in the engine 100 under a high temperature, the soot attached to the ignition plug 110 is also burnt together, so that the ignition plug 110 is cleaned up. As described above, it is estimated that burning is performed at a high temperature when any of the following conditions is detected: a condition that the coolant temperature of the coolant at the activation of the vehicle is high; a condition that the operating time of the engine 100 per one operation (one trip) is long; and a condition that the coolant temperature of the coolant at the time of the stop of the vehicle operation is high. As a result, it is expected that the ignition plug 110 is cleaned up. In such a case, in order to operate the electric VVT device 400 so as to improve the fuel efficiency, the control device 200 clears the counting value.

n some embodiments, the electric VVT device 400 is an electrically driven device. If the electric VVT device 40 is a hydraulic device, a motor pump can be employed for hydraulic generation. However, in a configuration that employs a mechanical pump powered by the engine 100, no hydraulic pressure occurs at the time when the engine 100 is started, and the advance amount of the electric VVT device 400 cannot be set freely. If the electric VVT device 400 is an electrically driven device, such a problem does not occur, and the advance amount can be set freely even at the time when the engine 100 is started.

In some embodiments, the motor generator MG2 to be use together with the engine 100 is further provided as a drive source of the vehicle. In some embodiments, the vehicle 1 further includes the power storage device 10 that supplies an electric power to the motor generator MG2, and the power storage device 10 is configured to be chargeable from outside the vehicle.

In a case of a hybrid vehicle and a plug-in hybrid vehicle, the frequency to operate the engine 100 decreases as compared with normal vehicles. Accordingly, a short trip that causes soot to be attached to the ignition plug 110 easily occurs. In view of this, in a case of the hybrid vehicle and the plug-in hybrid vehicle, the control described in the present embodiment is effective in particular.

Note that the present embodiment exemplifies a hybrid vehicle using an engine and a motor generator as a driving force source. However, the present embodiment is not limited to this, and can be applied to a vehicle provided with an engine having a VVT mechanism.

It should be considered that the embodiment described herein is just an example in all respects and is not limitative. A scope of the present disclosure is shown by Claims, not by the descriptions of the above embodiment, and intended to include every modification made within the meaning and scope equivalent to Claims.

What is claimed is:

1. A control device for an internal combustion engine, the internal combustion engine being provided in a vehicle, the internal combustion engine including an intake valve and a variable valve mechanism, the variable valve mechanism being configured to change an opening timing and a closing timing of the intake valve while maintaining a valve opening period of the intake valve, the control device comprising
a controller configured to set an advance amount of the closing timing of the intake valve at the time when the internal combustion engine is started, such that a first closing timing of the intake valve is earlier than a second closing timing of the intake valve, the first closing timing being the closing timing when a trip in which an operating period of the internal combustion engine is equal to or less than a predetermined period continues a predetermined number of times, the second closing timing being the closing timing before the number of continuous trips reaches the predetermined number of times, the trip being a period from activation of the vehicle to stop of the vehicle.

2. The control device according to claim 1, wherein
the controller is configured to set an advance amount of the variable valve mechanism to a most retarded position before the number of continuous trips reaches the predetermined number of times.

3. The control device according to claim 1, wherein
the controller is configured to count up a counting value that counts the number of continuous trips, when an operating time of the internal combustion engine in a immediately preceding trip is equal to or less than the predetermined period when the vehicle stops, and
the controller is configured to clear the counting value at the time when at least any one of the following conditions is established:
a condition that a coolant temperature of a coolant of the internal combustion engine at the activation of the vehicle is higher than a predetermined temperature;
a condition that the operating period of the internal combustion engine per one operation of the vehicle exceeds the predetermined period; and
a condition that the coolant temperature at the time when the vehicle operation is finished is higher than a predetermined temperature.

4. The control device according to claim 1, wherein the variable valve mechanism is an electrically driven mechanism.

5. The control device according to claim 1, wherein the vehicle includes a motor, the motor is used with the internal combustion engine as a drive source.

6. The control device according to claim 5, wherein
the vehicle includes a power storage device configured to supply an electric power to the motor, and
the power storage device is configured to be chargeable from outside the vehicle.

7. A control method for an internal combustion engine, the internal combustion engine being provided in a vehicle, the internal combustion engine including an intake valve and a variable valve mechanism, the variable valve mechanism being configured to change an opening timing and a closing timing of the intake valve while maintaining a valve opening period of the intake valve, the control method comprising:
setting an advance amount of a closing timing of the intake valve at the time when the internal combustion engine is started, such that a first closing timing of the intake valve is earlier than a second closing timing of the intake valve, the first closing timing being the closing timing when a trip in which an operating period of the internal combustion engine is equal to or less than a predetermined period continues a predetermined number of times, the second closing timing being the closing timing before the number of continuous trips reaches the predetermined number of times, the trip being a period from activation of the vehicle to stop of the vehicle.
